(19) United States
(12) Patent Application Publication
(10) Pub. No.: US 2015/0162798 A1
(43) Pub. Date: Jun. 11, 2015

(54) BRUSHLESS MOTOR

(71) Applicant: Mitsuba Corporation, Kiryu-shi, Gunma (JP)

(72) Inventors: Yuta Ozawa, Kiryu-shi (JP); Takumi Arao, Kiryu-shi (JP); Masaki Tanaka, Kiryu-shi (JP); Naoto Matsuoka, Kiryu-shi (JP)

(21) Appl. No.: 14/357,068

(22) PCT Filed: Nov. 7, 2012
(86) PCT No.: PCT/JP2012/078847

§ 371 Date: May 8, 2014

(30) Foreign Application Priority Data
Nov. 11, 2011 (JP) 2011-247752

(51) Int. Cl. H02K 5/16; H02K 5/22; H02K 11/00

(52) U.S. Cl. CPC H02K 5/161; H02K 11/0031; H02K 5/22

(57) ABSTRACT

A brushless motor includes a stator 11 which forms a rotating magnetic field, a rotor 12 which is rotated by the rotating magnetic field, a motor case 13 to which the stator 11 is attached, a bracket 16 which is interposed between the motor case 13 and a gear box 15, and a resolver 21 which detects the rotational angle of the rotor 12. The brushless motor further includes a first bearing 14 and a second bearing 20, which rotatably support the rotor 12. The first bearing 14 and the second bearing 20 are disposed at mutually different positions in the direction along the axis A serving as a rotation center of the rotor 12. In the direction along the axis A, the second bearing 20 is disposed on an interior side of the gear box 15 with respect to the position at which the bracket 16 is attached to the gear box 15. Accordingly, the moment generated when the rotor 12 vibrates can be reduced.

### CROSS-REFERENCE TO RELATED APPLICATION

This application is entitled to the benefit of and incorporates by reference subject matter disclosed in International Patent Application No. PCT/JP2012/078847 filed on Nov. 7, 2012 and Japanese Patent Application No. JP2011-247752 filed on Nov. 11, 2011.

### TECHNICAL FIELD

The present invention relates to a brushless motor having a stator core and a rotor rotating in the stator core.

### BACKGROUND

Conventionally, a brushless motor that does not have a current-carrying brush and is excellent in control performance has been known, and an example of the brushless motor is described in Japanese Patent Application Laid-Open Publication No. 2007-185047. The motor (brushless motor) described in Japanese Patent Application Laid-Open Publication No. 2007-185047 is applied to an electric power steering unit, which is used as an assist for the operation of a steering of a vehicle. In the motor described in Japanese Patent Application Laid-Open Publication No. 2007-185047, main parts thereof are housed in a cylindrical motor case, and the interior space of the motor case is in an approximately sealed state. A rotor housed in the motor case has a rotor shaft. A magnet and a rotor core are attached to the rotor shaft. Also, a stator housed in the motor case is press-fitted to an inner peripheral surface of the motor case. The stator is opposed to an outer peripheral surface of the rotor. Furthermore, the stator has a structure in which an insulator is inserted in a stator core. A stator coil is wound around the insulator. Then, the rotor is rotated by causing a change in magnetic field between the stator and the rotor.

On the other hand, an end of the rotor shaft projects from one end face of the motor case. The rotor shaft is supported by two bearings provided at left and right ends, and the first bearing is supported by a bottom portion of the motor case. Also, a bracket is attached to an opening of the motor case, and the bracket is provided with a flange. The flange is configured to be coupled and fixed to a gear box unit serving as a transmission unit. The second bearing is provided on an inner periphery of the bracket. Specifically, the second bearing is disposed between the bracket and the rotor core in the direction along the axis of the rotor shaft. Furthermore, a resolver is provided between the bracket and the rotor shaft. The resolver has a resolver rotor attached to the rotor shaft and a resolver stator attached to a terminal block. The terminal block is fixed to the bracket with screws.

### SUMMARY OF THE INVENTION

Incidentally, if the vehicle to which the motor described in Japanese Patent Application Laid-Open Publication No. 2007-185047 is to be applied is vibrated in the vertical direction, the rotor may be vibrated in the radial direction due to the vibrations. Moreover, the rotor may be vibrated in the radial direction when the rotor itself is rotated. However, in the motor described in Japanese Patent Application Laid-Open Publication No. 2007-185047, both of the two bearings supporting the rotor shaft are disposed on the bottom side of the motor case with respect to the fixed position of the bracket and the gear box unit. Therefore, there is a problem that, if the moment generated when the rotor is vibrated is relatively increased, operating noise and vibrations become large.

An object of the present invention is to provide a brushless motor that can reduce the moment generated when a rotor is vibrated.

A brushless motor of the present invention includes a stator having a coil to which electric power is supplied, a rotor disposed on an inner side of the stator and rotated by a rotating magnetic field generated when the electric power is supplied to the coil, a motor case having an opening on at least one end thereof and having the stator fixed to an interior thereof, and a bracket covering the opening of the motor case and attached to a structural member, and the brushless motor further includes: a first bearing which is provided between the rotor and the motor case and rotatably supports the rotor; and a second bearing which is provided between the rotor and the bracket and rotatably supports the rotor. The first bearing and the second bearing are disposed at positions mutually different in a direction along an axis serving as a rotation center of the rotor, and in the direction along the axis, the second bearing is disposed on an interior side of the structural member with respect to a position at which the bracket is attached to the structural member, and the second bearing is disposed so that a center thereof in the direction along the axis is on a structural member side with respect to a virtual plane of the position at which the bracket is attached to the structural member.

The brushless motor of the present invention further includes: a resolver which detects a rotation angle of the rotor, an annular retaining member is fixed to the bracket, the resolver has a fixed-side member attached to the retaining member and a rotated-side member which is attached to the rotor and forms magnetic flux between the rotated-side member itself and the fixed-side member, and the second bearing is retained by the retaining member.

In the brushless motor of the present invention, the retaining member has a large-diameter portion and a small-diameter portion whose inner diameter is smaller than that of the large-diameter portion, the large-diameter portion and the small-diameter portion being arranged in the direction along the axis, and the second bearing is retained by the small-diameter portion.

In the brushless motor of the present invention, the fixed-side member is attached to the large-diameter portion.

In the brushless motor of the present invention, the fixed-side member is attached to an inner peripheral side of the large-diameter portion by press-fitting until reaching an approximately intermediate part in the direction along the axis.

In the brushless motor of the present invention, on one end side of the retaining member in the direction along the axis, a flange portion is provided, and the flange portion is fixed to the bracket by insert molding.

The brushless motor of the present invention is a drive source of a vehicle braking device.

According to the present invention, the second bearing is disposed on the interior side of the structural member with respect to the position at which the bracket is attached to the structural member in the direction along the axis serving as the rotation center of the rotor. Therefore, when the rotor is vibrated in the radial direction about the axis, the apparent length of the arm of the moment becomes relatively short from the support position of the rotor in the structural member to a free end of the rotor. Accordingly, the vibrations of the rotor can be reduced.

According to the present invention, the retaining member attached to the bracket has both of a function to retain the fixed-side member of the resolver and a function to retain the second bearing. Therefore, increase in the number of parts can be suppressed.

According to the present invention, since the brushless motor of the present invention is used as the drive source of the vehicle braking device, the present invention can support also a vehicle braking device for which silence and vibration-resistance strength are required.

### BRIEF DESCRIPTIONS OF THE DRAWINGS

FIG. 1 is a sectional view of a brushless motor of the present invention;

FIG. 2 is an exploded perspective view of parts constituting the brushless motor of the present invention;

FIG. 3 is a diagram showing the state before a cap is attached to a bracket in the brushless motor of the present invention;

FIG. 4 is an exploded perspective view of parts constituting the brushless motor of the present invention;

FIG. 5 is a schematic diagram of a braking device using the brushless motor of the present invention;

FIG. 6 is an explanatory diagram showing the process of welding parts constituting the brushless motor of the present invention; and

FIG. 7 is an enlarged view of a stator of a resolver constituting the brushless motor of the present invention.

### DETAILED DESCRIPTION

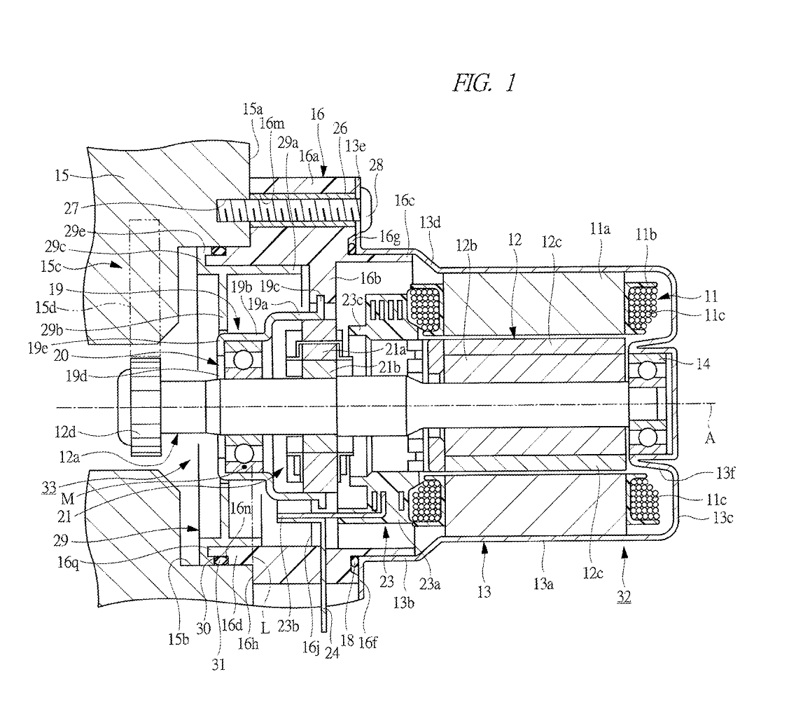

Hereinafter, an embodiment of a brushless motor of the present invention will be described based on drawings. As shown in FIG. 1, a brushless motor 10 of the present embodiment has a stator 11 and a rotor 12 which are disposed on the same axis A. The brushless motor 10 of the present embodiment is an inner rotor motor in which the rotor 12 is disposed in an inner space of the stator 11. The stator 11 has a stator core (stator iron core) 11a formed by stacking steel plates (not shown) which are magnetic materials, an insulator 11b attached to the stator core 11a, and a coil 11c wound around the insulator 11b. In the description of the present embodiment, the coil 11c is wound so as to correspond to three phases, that is, a U-phase, a V-phase, and a W-phase. Moreover, in the direction along the axis A, part of the insulator 11b and part of the coil 11c are disposed on both end sides of the stator core 11a.

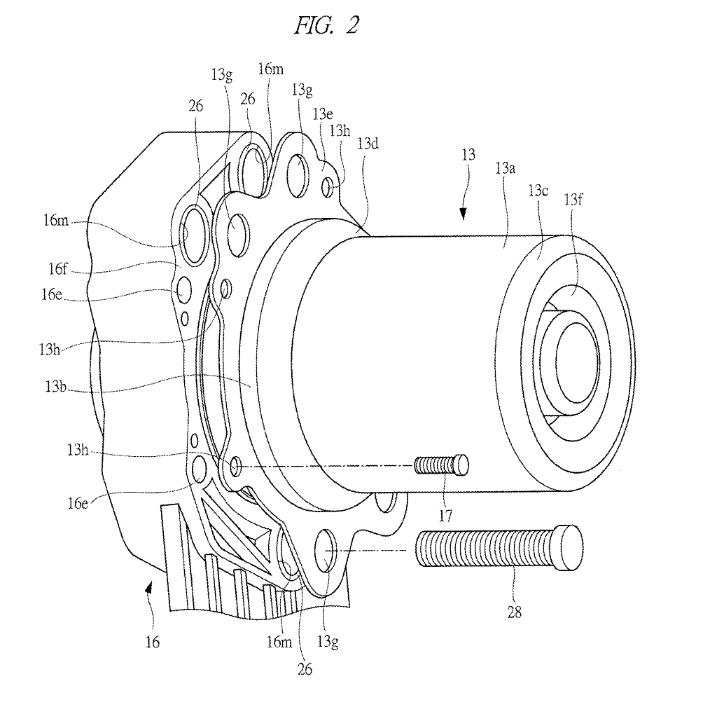

Furthermore, the brushless motor 10 has a motor case 13 which houses the stator 11, the rotor 12, and other parts. The motor case 13 is formed by press molding of a metal material such as iron, aluminum, or the like. Also, the outer surface of the motor case 13 is painted with black so as to improve the thermal emittance thereof. As shown in FIG. 1 and FIG. 2, the motor case 13 has a bottomed tubular shape that is open on one end and has a first cylindrical portion 13a, a second cylindrical portion 13b, a bottom portion 13c, a tapered portion 13d, and a flange 13e.

The first cylindrical portion 13a is disposed about the axis A, and the bottom portion 13c is formed to be continuous with one end of the first cylindrical portion 13a in the direction along the axis A. The tapered portion 13d is formed at the other end of the first cylindrical portion 13a on the opposite side of the bottom portion 13c, and the second cylindrical portion 13b is formed at one end of the tapered portion 13d on the opposite side of the first cylindrical portion 13a. The inner diameter of the first cylindrical portion 13a is set to be smaller than the inner diameter of the second cylindrical portion 13b. In a plane including the axis A, the tapered portion 13d has a tilt in the direction along which the inner diameter thereof is increased as it gets closer to the second cylindrical portion 13b from the first cylindrical portion 13a.

The bottom portion 13c has a folded portion 13f which is bent in a U-shape or a V-shape toward the interior side of the motor case 13. The folded portion 13f is formed across the entire circumference about the axis A. Also, in the radial direction about the axis A, the folded portion 13f is disposed on the inner side of the insulator 11b and the coil 11c. Furthermore, in the direction along the axis A, the disposed regions of part of the insulator 11b and part of the coil 11c and the disposed region of the folded portion 13f are partially overlapped with each other.

On the other hand, the rotor 12 has a rotating shaft 12a which is rotatable about the axis A. Also, in the direction along the axis A, about half of the rotating shaft 12a is positioned inside the motor case 13, and about the other half thereof is positioned outside the motor case 13. A rotor core 12b is attached to the part of the rotating shaft 12a that is positioned inside the motor case 13, more specifically, the outer periphery of the part positioned inside the stator core 11a. A permanent magnet 12c which generates magnetic fields is fixed to the outer peripheral part of the rotor core 12b by fixing means such as a magnet holder or a magnet cover. Also, an end of the rotating shaft 12a on the bottom portion 13c side is disposed inside the folded portion 13f.

A bearing 14 as a first bearing is provided inside the folded portion 13f, and one end of the rotating shaft 12a is rotatably pivotally supported by the bearing 14. The bearing 14 is a radial bearing which receives the load in the radial direction about the axis A. Furthermore, in the direction along the axis A, the disposed regions of part of the insulator 11b and the coil 11c and the disposed region of the bearing 14 are partially overlapped with each other. Note that a gear 12d is fixed to the part of the rotating shaft 12a that is positioned outside the motor case 13. In more specific description, the motor case 13 is attached to a later-described gear box 15 with a later-described bracket 16 interposed therebetween. Also, a later-described cylindrical member 19 is fixed to the bracket 16 by insert molding. Further, the gear 12d is fixed to the part of the rotating shaft 12a that is positioned outside a through hole 19d of the cylindrical member 19.

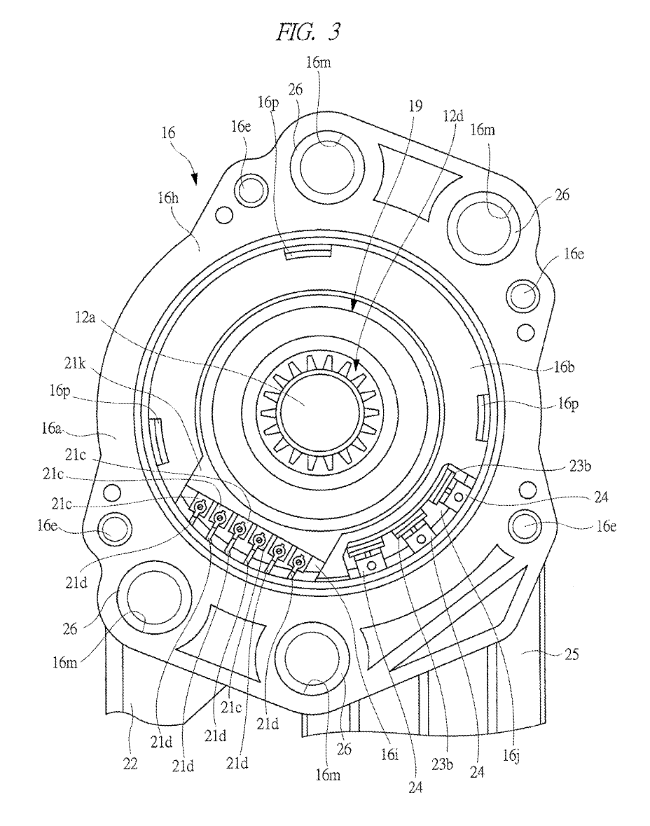

Next, a structure for fixing the brushless motor 10 to the gear box 15 serving as a structural member will be described with reference to FIG. 1 and FIG. 2. The gear box 15 is made of a metal material such as aluminum. Also, the brushless motor 10 is provided with the bracket 16 which is attached so as to cover an opening of the motor case 13. The bracket 16 is interposed between the motor case 13 and the gear box 15. The bracket 16 is formed by integral molding of a material such as a resin material having heat conductivity lower than that of the metal material constituting the motor case 13. The bracket 16 has an annularly-formed main body portion 16a and a flange 16b which projects from the main body portion 16a toward the inside in the radial direction thereof. As shown in FIG. 3, the flange 16b is provided in an arc shape along the circumferential direction thereof. Further, the bracket 16 has a first inlay portion 16c which is extended from the main body portion 16a toward the stator 11 side in the direction along the axis A and a second inlay portion 16d serving as a fit-in portion which is extended from the main body portion 16a in the direction away from the motor case 13 in the direction along the axis A, that is, in the direction opposite to that of the first inlay portion 16c.

The first inlay portion 16c has a cylindrical shape about the axis A, and the first inlay portion 16c is fitted in the second cylindrical portion 13b of the motor case 13. In other words, the bracket 16 is attached to the opening of the motor case 13. Also, the flange 13e of the motor case 13 is in contact with an end face 16f of the main body portion 16a and is provided with holes 13g and 13h penetrating through the flange 13e in the thickness direction thereof. Further, screw members 17 are inserted in the holes 13h. A plurality of female threads 16e are formed on the main body portion 16a, and the screw members 17 are screwed in the female threads 16e, so that the motor case 13 is fastened and fixed to the bracket 16.

An attachment groove 16g is formed at a boundary part of the end face 16f of the main body portion 16a and the first inlay portion 16c. The attachment groove 16g is annularly formed about the axis A. The attachment groove 16g has a depth in the direction along the axis A, and an annular O-ring 18 serving as a sealing member is attached to the attachment groove 16g. The O-ring 18 is a publicly known one made of a rubber-like elastic body. The O-ring 18 is an element for preventing foreign matters such as oil and dust present outside the brushless motor 10 from entering the brushless motor 10 through the contact part of the motor case 13 and the bracket 16. The O-ring 18 is in contact with three parts such as the bottom surface of the attachment groove 16g, the outer peripheral surface of the first inlay portion 16c, and the end face of the flange 13e, thereby forming a seal surface.

On the other hand, the cylindrical member 19 having a cylindrical shape is fixed to the inner periphery of the flange 16b. The cylindrical member 19 is formed by pressing a metal material. The cylindrical member 19 is provided with an outer edge portion (flange portion) 19c flared toward the outer side in the radial direction thereof. The outer edge portion 19c is embedded in the part of the flange 16b of the bracket 16 and integrated with the bracket 16 by insert molding at the time of resin molding. The insert molding will be described later. The cylindrical member 19 has a large-diameter portion 19a and a small-diameter portion 19b whose inner diameter is smaller than that of the large-diameter portion 19a, and the large-diameter portion 19a and the small-diameter portion 19b are arranged in the direction along the axis A. Also, at an end of the small-diameter portion 19b on the opposite side of the large-diameter portion 19a, a flange 19e flared toward the inner side in the radial direction thereof is formed. The through hole 19d is formed on an inner side of the flange 19e, and the rotating shaft 12a is inserted in the through hole 19d.

Specifically, in the direction along the axis A, the large-diameter portion 19a is provided at a position closer to the stator 11 than the small-diameter portion 19b is. Also, the outer edge portion 19c is formed by bending an opening end of the large-diameter portion 19a on the stator 11 side toward the outer side, and the outer edge portion 19c is fixed to the inner periphery of the flange 16b. In this manner, the cylindrical member 19 having the large-diameter portion 19a, the small-diameter portion 19b, the outer edge portion 19c, and the flange 19e is integrally molded by pressing a metal plate material. Further, in the direction along the axis A, the small-diameter portion 19b is disposed between the large-diameter portion 19a and the gear 12d. Furthermore, an outer ring of a bearing 20 serving as a second bearing is retained by the small-diameter portion 19b and the flange 19e so as not to be able to move in the radial direction and the axial direction. Moreover, an inner ring of the bearing 20 is fitted and fixed to the rotating shaft 12a. The bearing 20 is a radial bearing which receives the load in the radial direction about the axis A, and the other end of the rotating shaft 12a is rotatably supported by the bearing 20. The rotor 12 is rotatably pivotally supported about the axis A by the above-described two bearings 14 and 20.

In the direction along the axis A, the bearing 20 is disposed on the interior side of the gear box 15 with respect to the position at which the bracket 16 is attached to to the gear box 15. The position at which the bracket 16 is attached to the gear box 15 mentioned here means the contact part of the gear box 15 and the bracket 16. In the present embodiment, the contact part of an end face 15a of the gear box 15 and an end face 16h of the bracket 16 is considered as “attachment position (attachment surface)”. In FIG. 1, when the attachment position is extended in a direction orthogonal to the axis A, part of the bearing 20 is disposed on the extended line L. Also, FIG. 1 shows an example in which the center M of the bearing 20 in the direction along the axis A is disposed at a position closer to the interior of the gear box 15 than the extended line L is (on the gear 12d side). The extended line L shows a virtual plane perpendicular to the axis A.

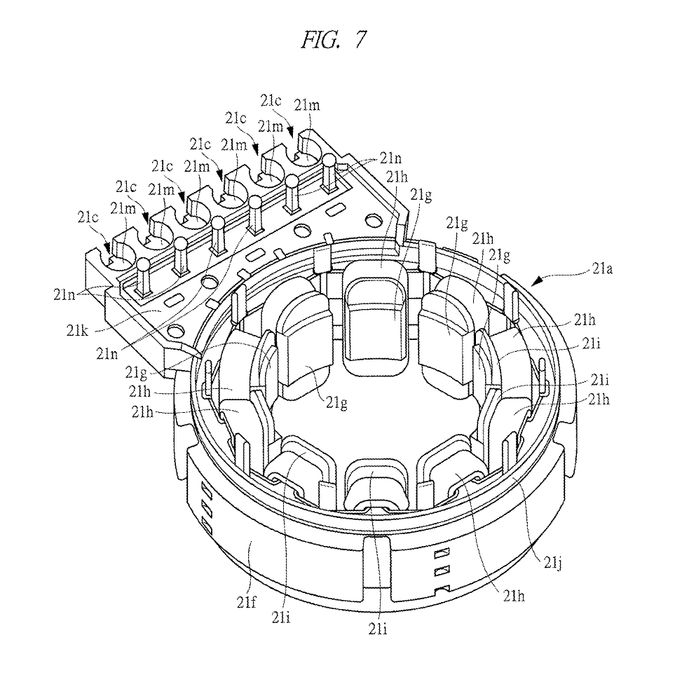

Also, the brushless motor 10 has a resolver 21 which detects the rotation angle of the rotor 12. The resolver 21 is press-fitted to the inner peripheral surface of the large-diameter portion 19a. The resolver 21 has a stator 21a and a rotor 21b. As shown in FIG. 7, the stator 21a has an annular stator core 21f, an annular portion 21j, a plurality of teeth 21g, and a plurality of coils 21h. The plurality of teeth 21g are disposed on the inner peripheral surface of the stator core 21f along the circumferential direction thereof. The plurality of teeth 21g project toward the inner side in the radial direction of the stator core 21f.

The annular portion 21j is fixed to one end of the stator core 21f in the direction along the axis A. A base portion 21k is provided on the outer periphery of the annular portion 21j. The annular portion 21j and the base portion 21k are formed by integral molding of a resin material. On the inner periphery of the annular portion 21j, a plurality of insulators 21i are provided. The plurality of insulators 21i are disposed along the circumferential direction of the annular portion 21j. The number of the plurality of insulators 21i is the same as the number of the plurality of teeth 21g. The plurality of insulators 21i and the plurality of teeth 21g are disposed at the same positions in the circumferential direction of the stator core 21f. Each of the plurality of coils 21h is independently wound around each of the teeth 21g via each insulator 21i. The rotor 21b is fixed to the outer periphery of the rotating shaft 12a. Between the rotor 21b and the stator 21a, a gap (air gap) in the radial direction of the stator 21a is formed.

As shown in FIG. 3 and FIG. 7, in the base portion 21k of the stator 21a, six stator terminals 21c are attached by embedding the center part thereof. Sensor terminals 21d are welded and fixed to the stator terminals 21c, respectively. The sensor terminals 21d are integrated with the main body portion 16a of the bracket 16 by insert molding. Also, each of the stator terminals 21c has a sensor-terminal connecting portion 21m and a coil connecting portion 21n which is continuous with the sensor-terminal connecting portion 21m and is provided at an end on an opposite side thereof. The coils 21h are independently electrically connected to the coil connecting portions 21n, respectively. Furthermore, the sensor terminals 21d are independently connected to the sensor-terminal connecting portions 21m, respectively. In this resolver 21, the insulators 21i are integrated with the stator core 21f together with the annular portion 21j and the base 21k by outsert molding.

Also, the stator 21a is press-fitted to the inner peripheral side of the large-diameter portion 19a until reaching an approximately intermediate part thereof in the direction along the axis A. The intermediate part mentioned here is an intermediate part of the stator core 21f of the stator 21a in the direction along the axis A. Also, it is the outer peripheral surface of the stator core 21f that is fitted with the inner peripheral surface of the large-diameter portion 19a, and the base 21k is disposed outside the cylindrical member 19. Therefore, the base 21k does not interfere with the cylindrical member 19. Further, since the outer edge portion 19c is formed by bending of the large-diameter portion 19a, the strength of this bent part is increased by this bending process (work hardening). Thus, the load in press-fitting the stator core 21f of the stator 21a into the large-diameter portion 19a of the cylindrical member 19 is received by the bent part between the large-diameter portion 19a and the outer edge portion 19c, with the result that concentration of stress onto the small-diameter portion 19b can be suppressed. Therefore, the positional accuracy of the bearing 20 in the direction along the axis A or the positional accuracy of the bearing 20 in the radial direction about the axis A can be maintained.

On the other hand, the flange 16b of the bracket 16 is provided with a first opening 16i between the flange 16b and the outer edge portion 19c of the cylindrical member 19. The spaces positioned on both sides of the flange 16b in the direction along the axis A are communicated with each other by the first opening 16i. Also, the sensor-terminal connecting portions 21m are formed at the ends of the stator terminals 21c on the opposite side of the coil connecting portions 21n. The sensor-terminal connecting portions 21m are exposed from the base portion 21k. The electrical connection parts of the sensor-terminal connecting portions 21m and the sensor terminals 21d are disposed in the vicinity of the first opening 16i. Also, a sensor connector 22 flared from the main body portion 16a of the bracket 16 toward the outside in the radial direction is provided. The sensor connector 22 is configured so that a connector of a power supply cord which is connected to an external power supply (now shown) is attached/detached. Also, ends of the sensor terminals 21d are attached to the sensor connector 22.

Furthermore, when an excitation voltage is applied to the stator 21a of the resolver 21 from the external power supply via the sensor terminals 21d and the stator terminals 21c, magnetic flux is generated in the gap between the stator 21a and the rotor 21b. The resolver 21 is connected to an electronic control device (not shown), and detection signals of the resolver 21 are processed by the electronic control device. The electronic control device is configured to obtain the rotation angle of the rotor 12 based on a change in the magnetic flux resistance (gap permeance) between the rotor 21b and the stator 21a.

As shown in FIG. 1, a bus bar unit 23 is provided in the motor case 13, specifically, between the insulator 11b and the flange 16b in the direction along the axis A. The bus bar unit 23 is annularly disposed so as to surround the outer peripheral side of the rotating shaft 12a and is attached to the insulator 11b. The bus bar unit 23 is formed by embedding bus bars in a resin mold body 23a. The number of provided bus bars is set so as to correspond to the number of the phases of the coil 11c of the stator 11. In the present embodiment, three bus bars are provided so as to correspond to the U-phase, the V-phase, and the W-phase. Also, bus bar terminals 23b are connected to the bus bars, respectively, and each of the bus bar terminals 23b is extended in the direction along the axis. Ends of the bus bar terminals 23b reach the outside of the large-diameter portion 19a.

Furthermore, as shown in FIG. 1 and FIG. 2, the flange 16b of the bracket 16 is provided with a second opening 16j penetrating in the direction along the axis A. Each of the ends of the bus bar terminals 23b is inserted into the second opening 16j, and power terminals 24 are welded and fixed to the bus bar terminals 23b, respectively. On the other hand, intermediate parts of the power terminals 24 are insert-molded with the main body portion 16a of the bracket 16, and a power connector 25 is integrally provided with the main body portion 16a on the radially outer side of the main body portion 16a. Ends of the three power terminals 24 are attached to the power connector 25. The power connector 25 is configured so that a connector of a power supply cord connected to the external power supply is attached/detached. Thus, the power supplied from the external power supply to the brushless motor 10 is controlled based on a control signal of a controller (not shown), so that the stop, rotation, rotating speed, rotating direction, and others of the brushless motor 10 are controlled.

On the other hand, a retainer 23c obtained by extending part of the resin mold body 23a toward the stator 21a in the direction along the axis A is provided. The retainer 23c functions as a stopper for preventing the stator 21a of the resolver 21 from moving in the direction in which it is removed from the large-diameter portion 19a. The retainer 23c is provided on the same circumference as that of the stator 21a across the entire circumference about the axis A. Furthermore, in a state in which the motor case 13 and the bracket 16 are fixed, the stator 11 is fixed to the motor case 13, and the stator 21a of the resolver 21 is fixed to the large-diameter portion 19a, a predetermined gap is formed in the direction along the axis A between the retainer 23c and the stator 21a. In other words, the retainer 23c and the stator 21a are not in contact with each other.

Furthermore, in the main body portion 16a, attachment holes 16m are provided on the radially outer side with respect to the second cylindrical portion 13b of the motor case 13. The attachment holes 16m penetrate through the main body portion 16a in the direction along the axis A. The plurality of attachment holes 16m are provided at the positions which are mutually different in the circumferential direction about the axis A, and collars 26 having cylindrical shapes are fixed to the plurality of attachment holes 16m, respectively, by insert molding, press-fitting, or the like. The collars 26 are made of a metal material such as aluminum or iron having higher thermal conductivity than that of the resin material constituting the bracket 16. On the other hand, female threads 27 are formed on the gear box 15. Also, screw members 28 serving as fastening members are inserted in the holes 13g of the flange 13e of the motor case 13, and the screw members 28 are screwed and fastened into the female threads 27 through the collars 26, so that the bracket 16 is fixed to the gear box 15 and the brushless motor 10 is thus fixed to the gear box 15. In a state in which the bracket 16 is fixed to the gear box 15, one ends of the collars 26 in the direction along the axis A are in contact with the gear box 15, and the other ends of the collars 26 in the direction along the axis A are in contact with the motor case 13.

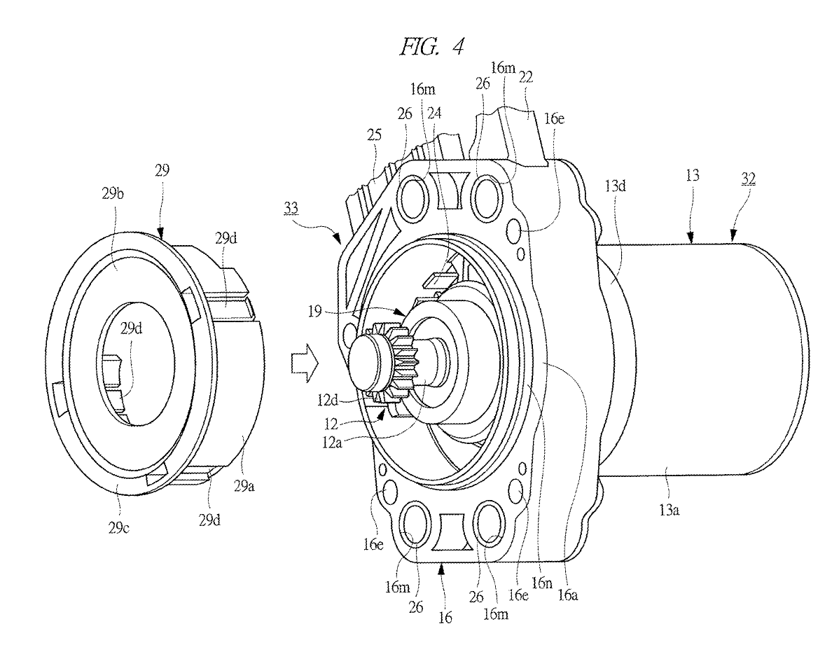

On the other hand, the gear box 15 is provided with an attachment hole 15b about the axis A. The second inlay portion 16d has a cylindrical shape about the axis A, and the bracket 16 is fixed to the gear box 15 in a state in which the second inlay portion 16d is inserted in the attachment hole 15b of the gear box 15. As shown in FIG. 1 and FIG. 4, a tip portion 16q having a smaller diameter than the second inlay portion 16d is formed on a tip side of the second inlay portion 16d via a step portion 16n. The step portion 16n is annularly formed about the axis A. Also, a cap 29 formed by integral molding of a resin material is attached to an opening end of the second inlay portion 16d. The cap 29 has a function to prevent foreign matters such as oil and dust from entering the brushless motor 10.

The cap 29 has a cylindrical portion 29a which is fitted to the inner periphery of the second inlay portion 16d and an annular flange 29b which is flared from the cylindrical portion 29a toward the inner side in the radial direction. The cylindrical portion 29a is provided with a plurality of latch pawls 29d at predetermined intervals in the circumferential direction (in the present embodiment, the latch pawls 29d are provided at three locations). Each of the latch pawls 29d is extended in the direction along the axis A, and each of the latch pawls 29d is configured to be elastically deformable in the radial direction of the cap 29 with using the end of the latch pawl 29d on the flange 29b side in the direction along the axis A as a fixed end.

On the other hand, as shown in FIG. 3, the flange 16b of the bracket 16 is provided with a plurality of latch holes 16p at predetermined intervals in the circumferential direction so as to correspond to the latch pawls 29d. By engaging the latch pawls 29d with the latch holes 16p, the cap 29 is fixed to the bracket 16. In the direction along the axis A, the flange 29b is disposed so as to surround the outer side of the small-diameter portion 19b. The inner diameter of the flange 29b is set to be smaller than the outer diameter of the large-diameter portion 19a and be larger than the outer diameter of the small-diameter portion 19b.

More specifically, the inner peripheral end of the flange 29b and the small-diameter portion 19b of the cylindrical member 19 are in a state of being close to each other via a minute gap, and when the cap 29 is fixed to the bracket 16, both of the first opening 16i and the second opening 16j are blocked from the outside of the brushless motor 10 by the cap 29.

Furthermore, the end of the cylindrical portion 29a that is positioned outside the tip portion 16q of the second inlay portion 16d is provided with a flange 29c, which is flared toward the radially outer side so as to have a diameter larger than the outer diameter of the tip portion 16q and equal to the outer diameter of the second inlay portion 16d, and the outer edge portion of the flange 29c is provided with a folded piece 29e, which is formed to be folded back in the direction along the axis A. The folded piece 29e and the step portion 16n and the tip portion 16q of the second inlay portion 16d form an annular attachment groove 30. An O-ring 31 is attached to the attachment groove 30, and the O-ring 31 is in contact with the gear box 15 to form a seal surface. The O-ring 31 is a sealing member for preventing foreign matters such as dust present outside the gear box 15 from entering the gear box 15 through the gap between the gear box 15 and the bracket 16.

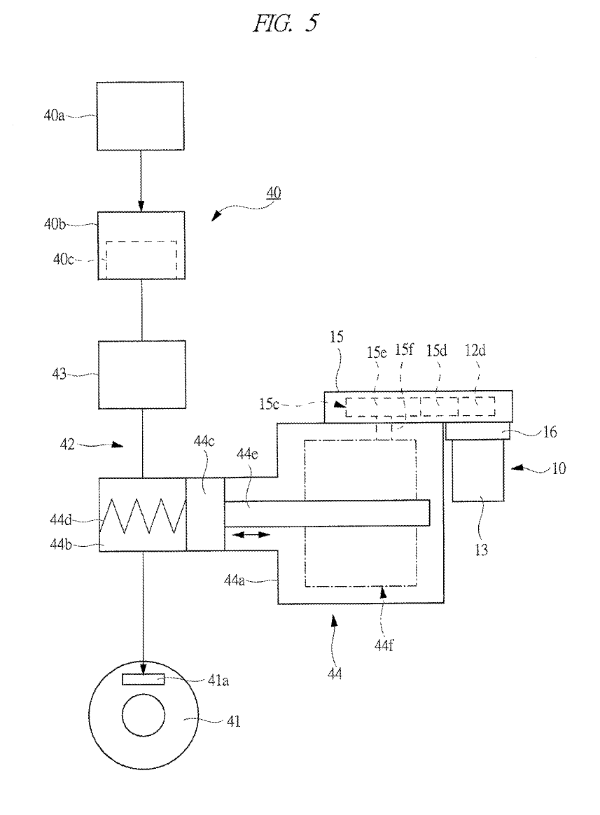

As shown in FIG. 5, a deceleration mechanism 15c is provided in the gear box 15. The deceleration mechanism 15c has an idler gear 15d and an output gear 15e which are meshed with each other. The idler gear 15d is meshed with the gear 12d. The output gear 15e is configured to integrally rotate with an output shaft 15f. The output shaft 15f is provided with a pinion gear (not shown). In the deceleration mechanism 15c configured in this manner, a transmission gear ratio is determined so that the rotating speed of the output gear 15e is lower than the rotating speed of the gear 12d when the torque of the gear 12d is transmitted to the output gear 15e via the idler gear 15d. The above-described cap 29 has both of a function to prevent foreign matters from entering the brushless motor 10 and a function to form the attachment groove 30 for attaching the O-ring 31.

When the electric power of an external power supply is supplied to the coil 11c via the power terminals 24 and the bus bar terminals 23b in a state in which the brushless motor 10 is fixed to the gear box 15, rotating magnetic fields are formed by the stator core 11a and the rotor 12 is rotated. The torque of the rotor 12 is transmitted to the deceleration mechanism 15c via the gear 12d. Also, when the rotor 12 is rotated, the magnetic flux resistance in the gap between the stator 21a and the rotor 21b of the resolver 21 is changed, and the rotation angle of the rotor 12 is detected.

In the brushless motor 10 of the present embodiment, the collars 26 are attached to the bracket 16, and the brushless motor 10 is fixed to the gear box 15 by the screw members 28 inserted in the collars 26. Also, the metal material constituting the collars 26 has higher heat conductivity than that of the resin material constituting the bracket 16. Therefore, when the stator 11 generates heat because of the power supply to the coil 11c, the heat is transmitted to the gear box 15 via the motor case 13 and the collars 26. In this manner, the collars 26 made of metal have a role as heat transmitting paths for transmitting heat from the motor case 13 to the gear box 15. Thus, it is possible to prevent the heat of the stator 11 from being transmitted to the resolver 21 and the bearing 20 via the bracket 16. Therefore, temperature increase of the resolver 21 is suppressed, and variations in the angle detection accuracy of the rotor 12 by the resolver 21 can be relatively reduced. Moreover, since heat is not easily transmitted to the bracket 16 in this structure, thermal expansion of the bracket 16 itself and thermal expansion of the bearing 20 can also be suppressed, and the positional accuracy of the bearing 20 can be maintained.

Further, in the direction along the axis A, part of the bearing 20 is disposed at a position closer to the interior of the gear box 15 than the contact face of the gear box 15 and the bracket 16 is, and the center of the bearing 20 in the direction along the axis A is on the gear 12d side with respect to the extended line L. Therefore, when the rotor 12 is rotated and vibrated in the radial direction or when vibrations are transmitted from the gear box 15 side to the brushless motor 10 to vibrate the rotor 12 in the radial direction, the length from a position serving as a supporting point to a free end of the rotor 12, that is, the length of the arm of moment can be shortened in appearance. Therefore, the moment generated by the vibrations of the rotor 12 can be reduced. As a result, reduction in the strength of the fixed part of the bracket 16 and the gear box 15 can be suppressed.

In the brushless motor 10 of the present embodiment, the collars 26 are attached to the bracket 16. The screw members 28 inserted in the collars 26 fix the brushless motor 10 to the gear box 15. Also, the heat conductivity of the metal material constituting the collars 26 is higher than the heat conductivity of the resin material constituting the bracket 16. Therefore, when the stator 11 generates heat because of power supply to the coil 11c, the heat is transmitted to the gear box 15 via the motor case 13 and the collars 26. In this manner, the collars 26 made of metal have a role as heat transmitting paths for transmitting heat from the motor case 13 to the gear box 15. Thus, it is possible to prevent the heat of the stator 11 from being transmitted to the resolver 21 and the bearing 20 via the bracket 16. Therefore, temperature increase of the resolver 21 is suppressed, and variations in the angle detection accuracy of the rotor 12 by the resolver 21 can be relatively reduced. Moreover, since heat is not easily transmitted to the bracket 16 in this structure, thermal expansion of the bracket 16 itself and thermal expansion of the bearing 20 can also be suppressed, and the positional accuracy of the bearing 20 can be maintained.

Also, in the direction along the axis A, part of the bearing 20 is disposed at a position closer to the interior of the gear box 15 than the contact face of the gear box 15 and the bracket 16 is. Furthermore, the center M of the bearing 20 in the direction along the axis A is disposed at a position closer to the gear 12d than the extended line L is. Therefore, when the rotor 12 is rotated and vibrated in the radial direction or when vibrations are transmitted from the gear box 15 side to the brushless motor 10 to vibrate the rotor 12 in the radial direction, the length from a position serving as a supporting point to a free end of the rotor 12, that is, the length of the arm of moment can be shortened in appearance. Therefore, the moment generated by the vibrations of the rotor 12 can be reduced. As a result, reduction in the strength of the fixed part of the bracket 16 and the gear box 15 can be suppressed.

In the direction along the axis A shown in FIG. 1, the retainer 23c is positioned on the lateral side of the stator 21a. Therefore, even if the force in the direction in which the stator 21a is removed from the cylindrical member 19 works, the stator 21a is brought into contact with the retainer 23c, so that the stator 21a is prevented from being dropped from the cylindrical member 19.

Furthermore, since the outer side of the motor case 13 is painted with black in the brushless motor 10 of the present embodiment, when the heat of the stator 11 is transmitted to the motor case 13, the heat dissipation performance to dissipate heat from the surface of the motor case 13 to the air is improved.

Furthermore, in the brushless motor 10 of the present embodiment, the disposed regions of ends of the insulator 11b and the coil 11c and the disposed region of the bearing 14 are partially overlapped with each other in the direction along the axis A. Therefore, the total length of the brushless motor 10 in the direction along the axis A can be relatively shortened, and the brushless motor 10 can be downsized.

Furthermore, in the present embodiment, the cylindrical member 19 has both of a function to retain the stator 21a of the resolver 21 and a function to retain the bearing 20. Therefore, increase in the number of parts of the brushless motor 10 can be suppressed.

Next, part of the process of manufacturing the parts of the brushless motor 10 will be described. The motor case 13 is formed by press molding of a metal material. Therefore, in the processing of the motor case 13, rollover due to fluidization of the metal material may occur at a bent part at which the second cylindrical portion 13b and the flange 13e are continuous with each other. On the other hand, the bracket 16, the cylindrical member 19, the sensor terminals 21d, and the power terminals 24 are integrated by so-called insert molding. Specifically, after the cylindrical member, the sensor terminals 21d, and the power terminals 24 are separately manufactured by processing metal materials, the cylindrical member 19, the sensor terminals 21d, and the power terminals 24 are disposed in a cavity of a mold, and the mold is closed, a resin material is injected into the cavity and solidified, thereby integrating the cylindrical member 19, the sensor terminals 21d, and the power terminals 24 with the bracket 16. As a result, the outer edge portion 19c of the cylindrical member 19 is insert-molded in the flange 16b of the bracket 16. Further, intermediate parts of the sensor terminals 21d in a longitudinal direction and intermediate parts of the power terminals 24 in a longitudinal direction are insert-molded in the main body portion 16a of the bracket 16. Moreover, the step portion 16n is formed on the outer periphery of the second inlay portion 16d of the bracket 16 during the insert molding.

Furthermore, since the insert molding is adopted, it is possible to use a mold which is divided in the radial direction of the bracket 16 to be molded or a mold which is divided in the direction of the axis A. In the brushless motor 10 of the present embodiment, the attachment groove 30 for attaching the O-ring 31 shown in FIG. 1 is formed of the folded piece 29e of the flange 29c, the step portion 16n of the second inlay portion 16d, and the tip portion 16q. More specifically, only part of the wall constituting the attachment groove is provided on the second inlay portion 16d side, and the outer shape of the second inlay portion 16d in the plane including the axis A is simplified. Therefore, the bracket 16 can be molded even with the mold including only upper and lower molds, it is not necessary to form the attachment groove by annularly cutting the outer periphery of the inlay portion of the bracket unlike the conventional techniques, and the processing of the bracket 16 is facilitated.

Next, assembling process of the brushless motor 10 will be described. First, a stator unit 32 and a motor sub-assembly 33 shown in FIG. 1 are separately assembled. The stator unit 32 is an intermediate assembly in which the stator core 11a, the insulator 11b, the coil 11c, and the bus bar unit 23 are attached in the motor case 13. The motor sub-assembly 33 is an intermediate assembly in which the bracket 16 and the cylindrical member 19 which are integrated, the rotor 12, the resolver 21, the bearing 20, and the O-ring 18 are mutually assembled. The stator core 21f of the resolver 21 is press-fitted to the inner peripheral surface of the large-diameter portion 19a of the cylindrical member 19 until reaching an approximately intermediate part thereof in the direction along the axis A. Therefore, the base portion 21k does not interfere with the cylindrical member 19. Also, when the stator core 21f is press-fitted to the inner peripheral surface of the large-diameter portion 19a of the cylindrical member 19, the press-fitting load thereof is received by the bent part between the large-diameter portion 19a and the outer edge portion 19c, with the result that concentration of stress onto the small-diameter portion 19b can be suppressed.

On the other hand, in the assembling process of the motor sub-assembly 33, the stator 21a of the resolver 21 is attached to the interior of the cylindrical member 19. As a result, as shown in FIG. 3, the ends of the sensor terminals 21d and the sensor-terminal connecting portions 21m of the stator terminals 21 come close to each other in the vicinity of the first opening 16i of the bracket 16. Then, before the motor sub-assembly 33 and the stator unit 32 are coupled, the ends of the sensor terminals 21d and the sensor-terminal connecting portions 21m of the stator terminals 21c are electrically welded and fixed to each other.

Also, in the process of mutually assembling the stator unit 32 and the motor sub-assembly 33, the O-ring 18 is attached to the attachment groove 16g of the bracket 16, the first inlay portion 16c is then inserted in the second cylindrical portion 13b, and the screw members 17 are fastened and fixed thereto. As a result, the O-ring 18 is compressed by the bracket 16 and the flange 13e of the motor case 13, and the O-ring 18 is brought into contact with the bracket 16 at two locations and is brought into contact with the motor case 13 at one location. In other words, since the O-ring 18 forms seal surfaces at three locations in total, even if there are variations in the shape of the motor case 13 due to rollover, the sealing property between the motor case 13 and the bracket 16 can be ensured in the brushless motor 10 after the completion of assembly.

Then, an operation of welding the power terminals 24 and the bus bar terminals 23b after the stator unit 32 and the motor sub-assembly 33 are mutually assembled will be described. At this point, as shown in FIG. 3, the cap 29 is not attached to the bracket 16. When the above-described stator unit 32 and the motor sub-assembly 33 are assembled, the bus bar terminals 23b are inserted in the second opening 16j. Thereafter, the power terminals 24 are inserted into the bracket 16 from a third opening 16k. As a result, the power terminals 24 and the bus bar terminals 23b come adjacent to each other.

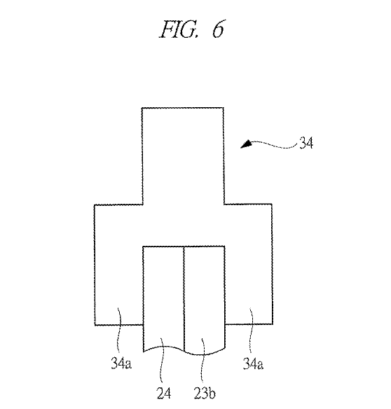

Then, as shown in FIG. 6, the end of the power terminal 24 and the end of the bus bar terminal 23b are brought into contact with each other and held (sandwiched) by a fixing part 34. The fixing part 34 is made of pure copper and has two holding portions 34a. The gap distance between the two holding portions 34a is set to be equal to or less than the total thickness of the power terminal 24 and the bus bar terminal 23b. Therefore, when the power terminal 24 and the bus bar terminal 23b are sandwiched by the two holding portions 34a, since the two holding portions 34a are elastically deformed in a direction in which the holding portions are opened and both of the terminals are strongly sandwiched by elastic restoring force, the power terminal 24 and the bus bar terminal 23b are brought into close contact with each other without any gap therebetween. Thereafter, the power terminal 24 and the bus bar terminal 23b are joined with each other by welding, for example, TIG welding together with the fixing part 34. In this manner, since the power terminal 24 and the bus bar terminal 23b are welded in the state in which the terminals are reliably brought into contact with each other by the fixing part 34, the welding quality is improved.

After the process of welding and fixing the ends of the power terminals 24 and the ends of the bus bar terminals 23b in the above-described manner is finished, the O-ring 31 is attached to the outer periphery of the second inlay portion 16d. Then, when the cap 29 is brought closer to the bracket 16 to engage the latch pawls 29d with the latch holes 16p, the cap 29 is fixed to the bracket 16, and assembling of the brushless motor 10 is completed. A snap-fit mechanism is formed in this manner by the latch pawls 29d and the latch holes 16p, and the cap 29 can be fixed to the bracket 16 by the single operation of pushing the cap 29 toward the bracket 16.

Also, when the cap 29 is fixed to the bracket 16, the inner peripheral end of the flange 29b and the small-diameter portion 19b of the cylindrical member 19 come close to each other via a minute gap therebetween. More specifically, when the cap 29 is fixed to the bracket 16, both of the first opening 16i and the second opening 16j can be blocked from the outside of the brushless motor 10 by the cap 29. Therefore, the assembling man-hours of the brushless motor 10 can be reduced compared with a case in which the first opening 16i and the second opening 16j are separately blocked.

Furthermore, the assembled brushless motor 10 and the gear box 15 are brought closer to each other to insert the second inlay portion 16d into the attachment hole 15b, and the end face 16h of the bracket 16 and the end face 15a of the gear box 15 are brought into contact with each other. Then, by inserting and fastening the screw members 28 into the collars 26, the brushless motor 10 is fixed to the gear box 15 as shown in in FIG. 1. When the brushless motor 10 is fixed to the gear box 15, the interior of the gear box 15 and the interior of the brushless motor 10 are blocked from each other by the cap 29. Therefore, it is possible to prevent foreign matters such as rainwater and dust from entering the brushless motor 10.

The brushless motor 10 of the present embodiment is used in a braking device 40 of a vehicle as shown in FIG. 5. The braking device 40 is configured so that the tread force applied to a brake pedal 40a is transmitted to a master cylinder 40b. Moreover, an oil passage 42 which transmits the oil pressure of an oil-pressure chamber 40c of the master cylinder 40b to a wheel cylinder 41a of a wheel 41 is provided. The oil passage 42 is provided with an on-off valve 43 and a motor-type oil-pressure control device 44. The on-off valve 43 is composed of, for example, a known solenoid valve, and a port connected to the oil passage 42 is opened/closed by switching conduction/non conduction of electric power thereto. An electronic control device (not shown) which controls open/close of the port of the on-off valve 43 is provided. The motor-type oil-pressure control device 44 has a cylinder main body 44a made of a metal material, an oil-pressure chamber 44b formed in the cylinder main body 44a, and a piston 44c provided to be movable in the cylinder main body 44a.

Further, the motor-type oil-pressure control device 44 has a spring 44d which presses the piston 44c in a predetermined direction and a plunger 44e which presses the piston 44c in the opposite direction of the spring 44d. Furthermore, the motor-type oil-pressure control device 44 has a power transmission mechanism 44f which is provided with a known ball screw mechanism in order to convert the rotary motion of the output shaft 15f to linear motion of the plunger 44e.

In the braking device 40 configured in the above-described manner, when the port of the on-off valve 43 is opened, the oil pressure of the oil-pressure chamber 40c of the master cylinder 40b is transmitted to the wheel cylinder 41a, and braking force corresponding to the oil pressure of the oil-pressure chamber 40c of the master cylinder 40b is generated. On the other hand, when the port of the on-off valve 43 is closed, the oil pressure of the oil-pressure chamber 40c of the master cylinder 40b is not transmitted to the wheel cylinder 41a, and the oil pressure of the oil-pressure chamber 44b is transmitted to the wheel cylinder 41a. The oil pressure of the oil-pressure chamber 44b is adjusted by controlling the power supply to the coil 11c of the brushless motor 10.

As described above, the brushless motor 10 of the present embodiment can be used in a device, in which high controllability, that is, high detection accuracy of the rotation angle of the rotor is required, as an actuator such as a vehicle braking device which controls the braking force applied to the wheel 41.

The correspondence relation between the configuration described in the present embodiment and the configuration of the present invention will be described. The stator 11 corresponds to a stator of the present invention, the rotor 12 corresponds to a rotor of the present invention, and the gear box 15 corresponds to a structural member of the present invention. Also, the cylindrical member 19 corresponds to a retaining member of the present invention, the stator 21a corresponds to a fixed-side member of the present invention, and the rotor 21b corresponds to a rotated-side member of the present invention. Further, the bearing 14 corresponds to a first bearing of the present invention, and the bearing 20 corresponds to a second bearing of the present invention. Furthermore, the bus bar unit 23 corresponds to an electric-power supplying member of the present invention, the retainer 23c corresponds to a fall preventing member of the present invention, the second inlay portion 16d corresponds to a fit-in portion of the present invention, the attachment groove 30 corresponds to an attachment groove of the present invention, the attachment hole 15b corresponds to an attachment hole of the present invention, and the O-ring 31 corresponds to a sealing member of the present invention. Moreover, the brushless motor 10 corresponds to a drive source of the present invention.

Also, the present invention is not limited to the above-described embodiment, and it goes without saying that various modifications can be made within the scope of the present invention. The brushless motor of the present invention can be used also as an actuator of a power steering device of a vehicle. Also, regarding the disposed position of the bearing in the direction along the axis, when the attached position is extended in the direction orthogonal to the axis, the bearing can be entirely disposed on the interior side of the structural member with respect to the extended line. Also, the tubular members into which the screw members are inserted are not limited to cylindrical members whose cross-sectional shapes are circular, but may be rectangular tube members whose cross-sectional shapes are rectangular. Furthermore, the motor case 13 is not limited to be made of a metal material, but may be a case formed by integral molding of a resin material together with the stator core 11a.

Further, stud bolts may be provided in the structural member instead of the screw members 28. The bracket can be fixed to the structural member by inserting the stud bolts in tubular members and attaching and fastening nuts to male thread portions of the stud bolts. Further, it is also possible to provide the deceleration mechanism 15c in the cylinder main body 44a and fix the bracket 16 to the outer wall of the cylinder main body 44a without providing the gear box 15. If configured in this manner, the cylinder main body 44a corresponds to the structural member of the present invention. Furthermore, retainers 23c may be provided at predetermined intervals in the circumferential direction about the axis A. Also, any numbers of the screw members 28 and the screw members 17 may be provided as long as they are plural, and the numbers may be arbitrarily determined. Furthermore, operating members of the present invention include a lever, a knob, and other operated by hands in addition to a brake pedal operated by foot. Furthermore, to the structural member of the present invention, the brushless motor whose assembling is completed is fixed, and examples of the structural member of the present invention include a housing of a device and a frame of a structure in addition to the above-described gear box. Also, a rotating member of the present invention is an element which transmits the torque of the brushless motor to the power transmission mechanism, and examples of the rotating member of the present invention include various gears, pulleys, sprockets, and carriers of a planetary gear mechanism in addition to the above-described rotating shaft.

The present invention is applicable to a brushless motor having a stator core and a rotor rotating in the stator core.

While the present invention has been illustrated and described with respect to a particular embodiment thereof, it should be appreciated by those of ordinary skill in the art that various modifications to this invention may be made without departing from the spirit and scope of the present.

What is claimed is:

1. A brushless motor including a stator having a coil to which electric power is supplied, a rotor disposed on an inner side of the stator and rotated by a rotating magnetic field generated when the electric power is supplied to the coil, a motor case having an opening on at least one end thereof and having the stator fixed to an interior thereof, and a bracket covering the opening of the motor case and attached to a structural member, the brushless motor comprising:
a first bearing which is provided between the rotor and the motor case and rotatably supports the rotor; and
a second bearing which is provided between the rotor and the bracket and rotatably supports the rotor,
wherein the first bearing and the second bearing are disposed at positions mutually different in a direction along an axis serving as a rotation center of the rotor,
in the direction along the axis, the second bearing is disposed on an interior side of the structural member with respect to a position at which the bracket is attached to the structural member, and
the second bearing is disposed so that a center thereof in the direction along the axis is on a structural member side with respect to a virtual plane of the position at which the bracket is attached to the structural member.

2. (canceled)

3. The brushless motor according to claim 1, further comprising:
a resolver which detects a rotation angle of the rotor,
wherein an annular retaining member is fixed to the bracket,
the resolver has a fixed-side member attached to the retaining member and a rotated-side member which is attached to the rotor and forms magnetic flux between the rotated-side member itself and the fixed-side member, and
the second bearing is retained by the retaining member.

4. The brushless motor according to claim 3,
wherein the retaining member has a large-diameter portion and a small-diameter portion whose inner diameter is smaller than that of the large-diameter portion, the large-diameter portion and the small-diameter portion being arranged in the direction along the axis, and
the second bearing is retained by the small-diameter portion.

5. The brushless motor according to claim 4,
wherein the fixed-side member is attached to the large-diameter portion.

6. The brushless motor according to claim 5,
wherein the fixed-side member is attached to an inner peripheral side of the large-diameter portion by press-fitting until reaching an approximately intermediate part in the direction along the axis.

7. The brushless motor according to claim 3,
wherein, on one end side of the retaining member in the direction along the axis, a flange portion is provided, and
the flange portion is fixed to the bracket by insert molding.

8. The brushless motor according to claim 1,
wherein the brushless motor is a drive source of a vehicle braking device.

9. The brushless motor according to claim 4,
wherein, on one end side of the retaining member in the direction along the axis, a flange portion is provided, and
the flange portion is fixed to the bracket by insert molding.

10. The brushless motor according to claim 3,
wherein the brushless motor is a drive source of a vehicle braking device.

11. The brushless motor according to claim 4,
wherein the brushless motor is a drive source of a vehicle braking device.

12. The brushless motor according to claim 5,
wherein the brushless motor is a drive source of a vehicle braking device.

13. The brushless motor according to claim 6,
wherein the brushless motor is a drive source of a vehicle braking device.

14. The brushless motor according to claim 7,
wherein the brushless motor is a drive source of a vehicle braking device.

15. The brushless motor according to claim 9,
wherein the brushless motor is a drive source of a vehicle braking device.
